(19) United States
(12) Patent Application Publication
(10) Pub. No.: US 2014/0002443 A1
(43) Pub. Date: Jan. 2, 2014

(54) AUGMENTED REALITY INTERFACE

(71) Applicant: Benjamin Grady CUNNINGHAM, San Francisco, CA (US)

(72) Inventor: Benjamin Grady CUNNINGHAM, San Francisco, CA (US)

(73) Assignee: BLACKBOARD INC., Washington, DC (US)

(21) Appl. No.: 13/538,779

(22) Filed: Jun. 29, 2012

(51) Int. Cl. G09G 5/00; G06T 15/00

(52) U.S. Cl. 345/419

(57) ABSTRACT

Methods for augmenting a view of a physical environment with computer-generated sensory input are provided. In one aspect, a method includes receiving visual data providing for display an image of a physical three-dimensional environment and orientation data indicating an orientation of a device within the physical environment, and generating a simulated three-dimensional environment. The method also includes providing the image of the physical environment for display within the simulated environment, and providing at least one computer-generated visual object within the simulated environment for overlaying on the displayed image of the physical environment. The computer-generated visual object is displayed using perspective projection. Systems and machine-readable storage media are also provided.

### BACKGROUND

1. Field

The present disclosure generally relates to computer data, and more particularly to the use of a computing device to display data.

2. Description of the Related Art

Augmented reality (AR) is commonly described as a live, direct or indirect, view of a physical, real-world environment whose elements are augmented by computer-generated sensor input such as sound, video, graphics or global positioning system data. AR software applications are often used on mobile devices to assist users in finding physical objects or locations in the physical world by displaying computer-generated visual objects near the physical objects or locations.

AR software applications that provide a direct view of a physical world environment commonly use orthographic projection (or orthogonal projection) to display computer-generated visual objects. Orthographically projected virtual objects, however, often result in a virtual visual layout that is inconsistent with the human visual system. Consequently, a user's resulting visual experience of the virtual world is unnatural, inaccurate, and unintuitive. For example, as provided in the example illustration of FIG. 1, virtual objects that are far way 102 and 101 do not appear on tablet computer 110 as smaller than a virtual object 103 that is close by, but instead appear the same size regardless of their distance from the user.

Furthermore, the field of view parameters used by many such AR software applications make visual interaction with and the movement and positioning of virtual objects appear unnatural and inaccurate. Improper field of view parameters also undermine a desired visual relationship between a virtual object and its physical counterpart. Improper field of view parameters can result in virtual objects being displayed on-screen when in reality the physical objects they represent are not in view of the camera (e.g., in which case the chosen field of view is too large). Improper field of view parameters can also result in virtual objects not being displayed even when the represented physical object is on screen (e.g., in which case the chosen field of view is too small). Proper field of view parameters ensure that virtual objects always appear directly in front of their physical counterparts and move in concert as the device is rotated.

As an example of the difficulties with orthographic projection and improper field of view parameters, virtual objects 103 and 101 are not directly in front of the user, but are instead either to the left or right of the user. Nonetheless, all three virtual objects 101, 102, and 103 are displayed and angled as if they are directly in front of the user. Furthermore, certain virtual objects 101 and 103 are not properly aligned with their respective physical objects 104 and 105 because an improper field of view results in a distribution of virtual objects that are either too close to the center of the screen or too far from the center of the screen. If a user is directly facing a physical object (e.g., it is in the center of the screen), such as a tree 106, then the virtual object 102 identifying the tree may represent it correctly regardless of whether the field of view parameters are correct. Nonetheless, the virtual object 101 representing the table 104 is too far to the left and not properly aligned with the table 104. The virtual object 103 representing the bus stop 106 is too far to the right and not properly aligned with the bus stop 106. Thus, in this example, the values for the field of view parameters are too small.

### SUMMARY

Certain embodiments of the disclosure provide an augmented reality application that uses perspective projection and a properly configured field of view to display virtual objects with additional realism. For example, using perspective projection, virtual objects that are far way appear smaller than virtual objects that are close by. By overlaying virtual objects of a surface layer (e.g., invisible layer) on top of a device's camera display, matching the dimensions of the surface layer to the dimensions of the image from the camera, and matching the field of view of the surface layer to the field of view of the camera, the virtual objects move and rotate with greater realism and in accordance with the physical objects they represent in response to a user moving the device.

According to one embodiment of the present disclosure, a computer-implemented method for augmenting a view of a physical environment with computer-generated sensory input is provided. The method includes receiving visual data providing an image of a physical three-dimensional environment, and orientation data indicating an orientation of a device within the physical three-dimensional environment, and generating for display a simulated three-dimensional environment, wherein an orientation of the simulated three-dimensional environment is based on the orientation data indicating the orientation of the device within the physical three-dimensional environment, and the display of the simulated three-dimensional environment is based on the field of view of the device. The method also includes providing the image of the physical three-dimensional environment for display on the device within the simulated three-dimensional environment based on a field of view of the device, and providing at least one computer-generated visual object within the simulated three-dimensional environment for overlaying on the displayed image of the physical three-dimensional environment. The computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.

According to another embodiment of the present disclosure, a system for augmenting a view of a physical environment with computer-generated sensory input is provided. The system includes a memory that includes instructions, and a processor. The processor is configured to execute the instructions to receive visual data providing an image of a physical three-dimensional environment, and orientation data indicating an orientation of a device within the physical three-dimensional environment, and generate for display a simulated three-dimensional environment, wherein an orientation of the simulated three-dimensional environment is based on the orientation data indicating the orientation of the device within the physical three-dimensional environment, and the display of the simulated three-dimensional environment is based on the field of view of the device. The processor is also configured to execute the instructions to provide the image of the physical three-dimensional environment for display on the device within the simulated three-dimensional environment based on the field of view of the device, and provide at least one computer-generated visual object within the simulated three-dimensional environment for overlaying on the displayed image of the physical three-dimensional environment. The computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.

According to one embodiment of the present disclosure, a machine-readable storage medium includes machine-readable instructions for causing a processor to execute a method for augmenting a view of a physical environment with computer-generated sensory input is provided. The method includes receiving visual data providing an image of a physical three-dimensional environment, and orientation data indicating an orientation of a device within the physical three-dimensional environment, and generating for display a simulated three-dimensional environment, wherein an orientation of the simulated three-dimensional environment is based on the orientation data indicating the orientation of the device within the physical three-dimensional environment, and the display of the simulated three-dimensional environment is based on the field of view of the device. The method also includes providing the image of the physical three-dimensional environment for display on the device within the simulated three-dimensional environment, and providing at least one computer-generated visual object within the simulated three-dimensional environment for overlaying on the displayed image of the physical three-dimensional environment. The computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 provides an exemplary illustration of an augmented reality application according to the prior art.

FIG. 2 illustrates a block diagram illustrating an exemplary client configured to run an augmented reality application according to certain aspects of the disclosure.

FIG. 3 illustrates an exemplary process for presenting an augmented reality application on the exemplary client of FIG. 2.

FIGS. 4A-4G are exemplary illustrations associated with the exemplary process of FIG. 3.

FIG. 5 is a block diagram illustrating an exemplary computer system with which the client of FIG. 2 can be implemented.

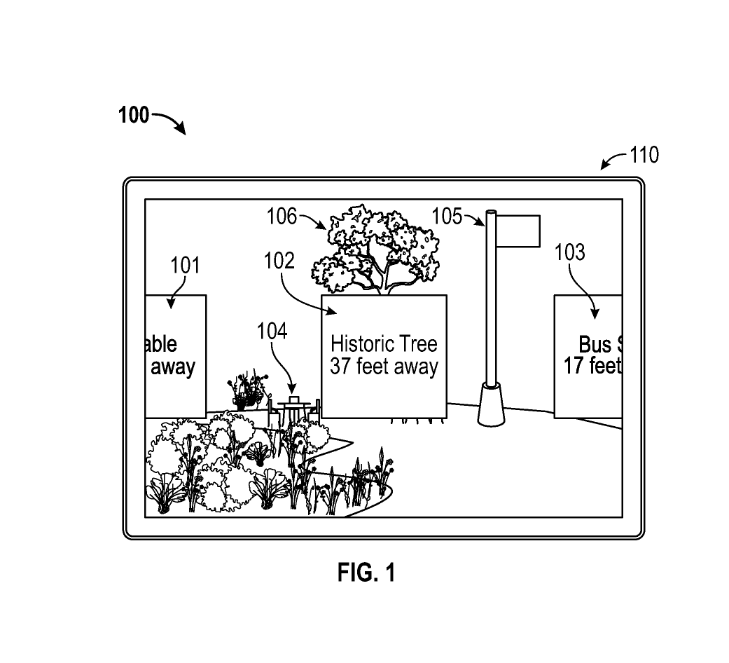

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

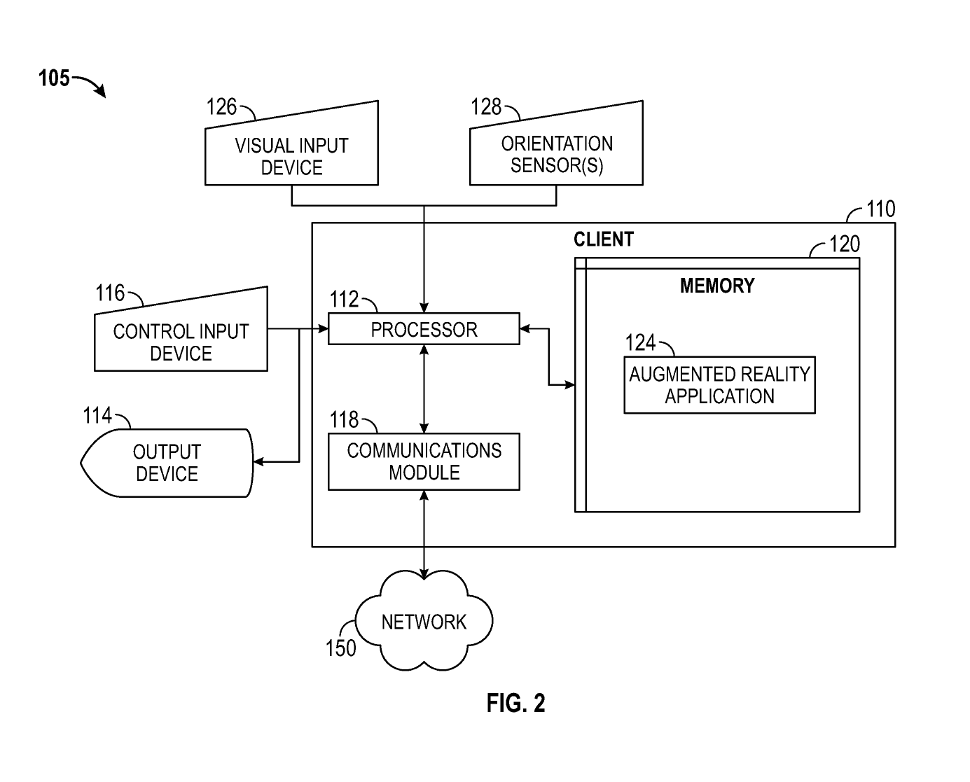

FIG. 2 is a block diagram 105 illustrating an exemplary client 110 according to certain aspects of the disclosure. The client 110 can be connected to a network 150 via a communications module 118, for example, in order to connect to a server. The communications module 118 is configured to interface with the network 150 to send and receive information, such as data, requests, responses, and commands to other devices on the network. The communications module 118 can be, for example, a modem or Ethernet card. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The client 110 includes a processor 112, a communications module 118, and a memory 120 that includes an augmented reality application 124. The client 110 also includes an output device 114, a control input device 116 (e.g., keyboard or touchscreen input), a visual input device 126 (e.g., camera lens), and orientation sensor(s) 128. The orientation sensor(s) can include, but are not limited to, a geolocation sensor (e.g., a Global Positioning System (GPS) device), a gyroscope, an accelerometer, and a compass. The client 110 can be, for example, a mobile device such as a smartphone, personal digital assistant, portable gaming console, or a tablet computer (e.g., including an e-book reader). The client 110 can also be another device capable of using an augmented reality application, such as a desktop computer or mobile computer, or any other devices having appropriate processor, memory, and communications capabilities.

The processor 112 of the client 110 is configured to execute instructions, such as instructions physically coded into the processor 112, instructions received from software in memory 120 (e.g., the augmented reality application 124), or a combination of both. For example, the processor 112 of the client 110 executes instructions to receive visual data (e.g., from visual input device 126) providing an image of a physical three-dimensional environment, and orientation data (e.g., from orientation sensor(s) 128) indicating an orientation of the client 110 within the physical three-dimensional environment. The visual data can be a video feed from a camera 126 of the client 110 or a sequence of images from the camera 126 of the client 110. The visual data can, for example, be a continuously updating video/image input, where at a moment in time the visual data represents an image of the physical environment. The orientation data can, for example, provide an estimate of a position and bearing of the client 110 on Earth. The orientation of the client 110 includes an approximate bearing value of the client 110 and thereby provides an orientation for the client 110 within the physical environment. The bearing value includes a compass bearing and an extent of rotation of the client 110 relative to the Earth. The rotation of the client 110 can be expressed in many different ways including, for example, a three-dimensional rotation matrix, Euler angles, or in quaternion. The position of the client 110 includes an approximate latitude and longitude of the client 110 and thereby provides a position of the client 110 within the physical environment.

The processor 112 of the client 110 is also configured to execute instructions to generate a simulated three-dimensional environment for display on the output device 114. The simulated three-dimensional environment is based on the orientation data indicating the orientation of the client 110 within the physical three-dimensional environment. The simulated three-dimensional environment is also based on position data (e.g., latitude and longitude) indicating the position of the client 110 within the physical three-dimensional environment. Consequently, basing the on-screen representation of a virtual object on the orientation data and the position data permits the virtual object to corresponds directly with a physical object present in the image of the physical three-dimensional environment. The simulated three-dimensional environment can be generated and displayed as a spherical three-dimensional environment or a flat three-dimensional environment (e.g., cuboid-shaped environment). The simulated three-dimensional environment can be generated and displayed in other three-dimensional shapes, such as but not limited to a cube, cylinder, hexagonal prism, cone, square-based pyramid, triangular based pyramid, or triangular prism. In certain aspects, the spherical three-dimensional environment is an advantageous way to capture a layout of a user's surroundings, and so is the chosen representation in the examples discussed herein.

The processor 112 of the client 110 is also configured to provide the image of the physical three-dimensional environment for display on the client 110 (e.g., on output device 114) within the simulated three-dimensional environment based on a field of view of the visual input device 126. For example, the image of the physical environment is taken from the visual input device 126, and then a surface layer (e.g., an invisible virtual layer) representing the simulated three-dimensional environment is overlaid on top of the image. The processor 112 is further configured to provide at least one computer-generated visual object within the simulated three-dimensional environment for overlaying on the displayed image of the physical three-dimensional environment. For example, a visual object such as a text box can be displayed within the surface layer. The visual object is displayed using perspective projection within the simulated three-dimensional environment onto the displayed image of the physical three-dimensional environment based on the orientation data indicating the orientation of the client 110 within the physical three-dimensional environment. Visual object data and other information for the simulated three-dimensional environment can be stored locally on the client 110 with the augmented reality application 124, and/or can be obtained over the network 150 from a server.

In certain aspects, the field of view of the user that is displayed by the client 110 (e.g., the image of the simulated three-dimensional environment) is set to match the field of view of the visual input device 126. Specifically, the chosen field of view of a perspective projection used to display the simulated three-dimensional environment is defined by a visual input device 126 (e.g., camera display input) of the client 110. In certain aspects, values indicating the field of view are not calculated, but are rather intrinsic properties of the visual input device 126. These values can be looked up depending on the visual input device 126. For example, the field of view values of the simulated environment can match those of the visual input device 126 directly. These field of view values are then used to calculate a perspective projection that is applied to the contents of the simulated three-dimensional environment. As a result, virtual objects are displayed on-screen when in reality the physical objects they represent are within view of the camera, and virtual objects are not displayed when the represented physical object is not on screen. In certain aspects, the field of view as discussed herein facilitates the display of virtual objects appearing directly in front of their physical counterparts, and their movement in concert with their physical counterparts as the client 110 is rotated.

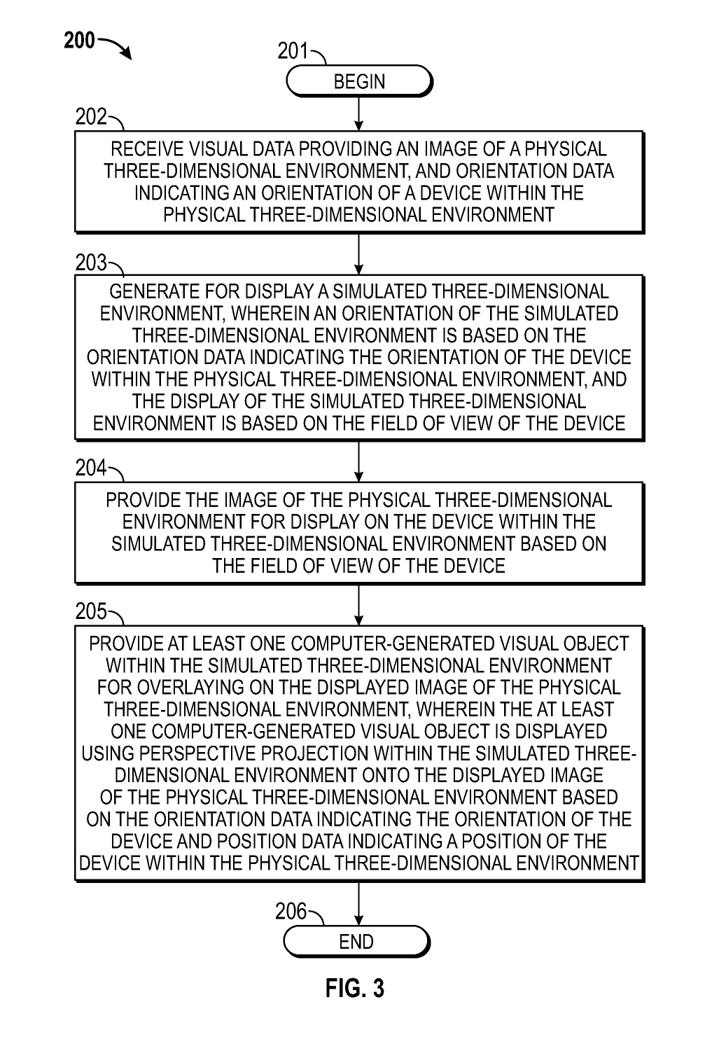

FIG. 3 is an exemplary process 200 for presenting an augmented reality application 124 on the exemplary client 110 of FIG. 2. The process 200 begins by proceeding from step 201 when a user, for example, loads the augmented reality application 124 on the client 110 to step 202, in which visual data providing an image of a physical three-dimensional environment is received, and orientation data indicating an orientation of the client within the physical three-dimensional environment is also received. Next, in step 203, a simulated three-dimensional environment is generated and rendered for display. The orientation of the simulated three-dimensional environment is based on the orientation data indicating the orientation of the client 110 within the physical three-dimensional environment. The rendered display of the simulated three-dimensional environment is based on the field of view parameters of visual input device 126. In subsequent step 204, the image of the physical three-dimensional environment is provided for display on the client 110 (e.g., on output device 114) within the simulated three-dimensional environment based on a field of view of the client 110. Next, in step 205, at least one computer-generated visual object is provided within the simulated three-dimensional environment for overlaying on the displayed image of the physical three-dimensional environment. Consequently, the visual object appears on top of a corresponding physical object within the image of the physical three-dimensional environment. The computer-generated visual object is displayed using perspective projection within the simulated three-dimensional environment onto the displayed image of the physical three-dimensional environment based on the orientation data indicating the orientation of the client 110 within the physical three-dimensional environment. The process 200 then ends in step 206.

FIG. 3 sets forth an exemplary process 200 for presenting an augmented reality application 124 on the exemplary client 110 of FIG. 2. An example will now be described using the exemplary process 200 of FIG. 3 and a student user carrying a tablet computer as the client 110 on the user's educational institution campus.

The process 200 begins by proceeding from step 201 when the student user loads the augmented reality application 124 on the tablet computer 110 to assist the student user with navigating the institution campus. The student user is a new student to the institution campus. In step 202, visual data from the tablet computer's 110 camera 126 provides an image of the institution campus, and orientation data from the tablet computer's GPS device, gyroscope, compass, and accelerometer 128 provide an orientation of the tablet computer 110 within the world, and specifically, on the institution campus. Next, in step 203, a simulated three-dimensional environment is generated and rendered. The orientation of the simulated three-dimensional environment is based on the orientation data indicating the orientation of the client 110 within the physical three-dimensional environment. For example, the simulated three-dimensional environment is aligned in bearing, latitude, and longitude to the image of the physical three-dimensional environment. The rendered display of the simulated three-dimensional environment is based on the field of view parameters of the camera 126.

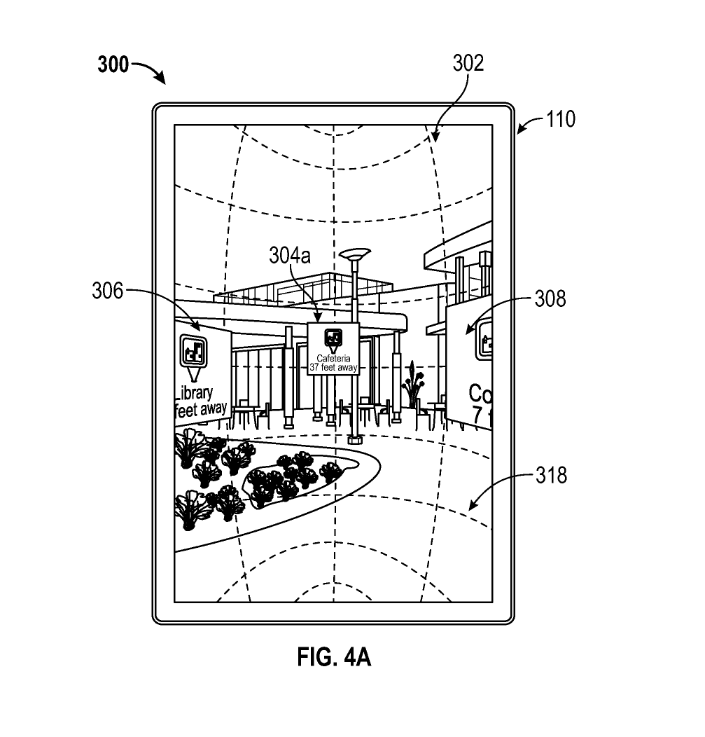

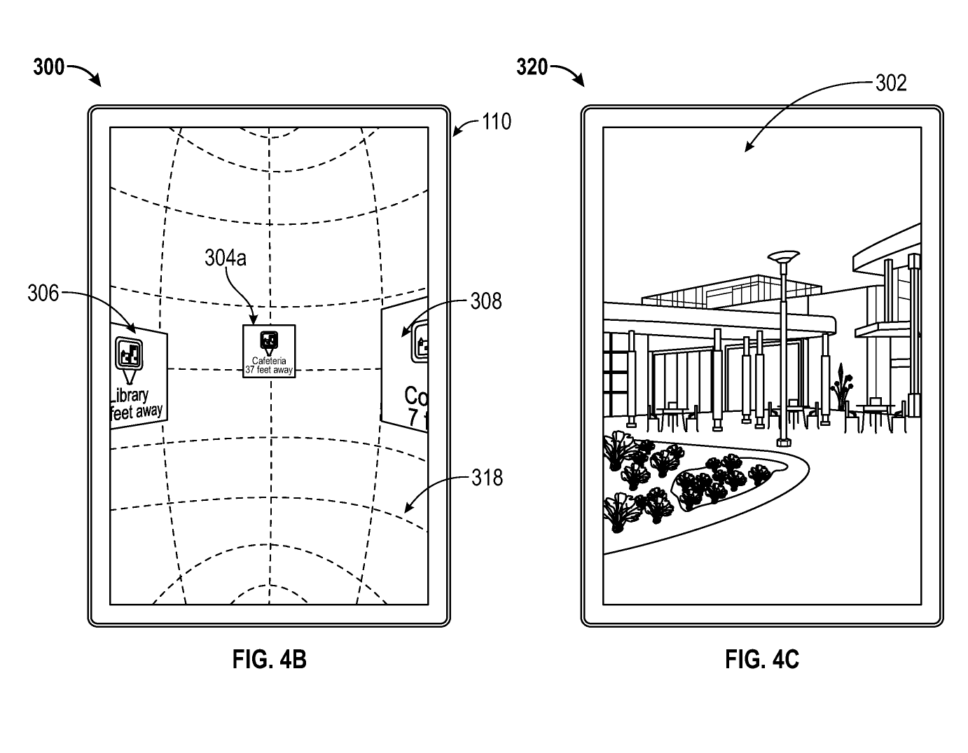

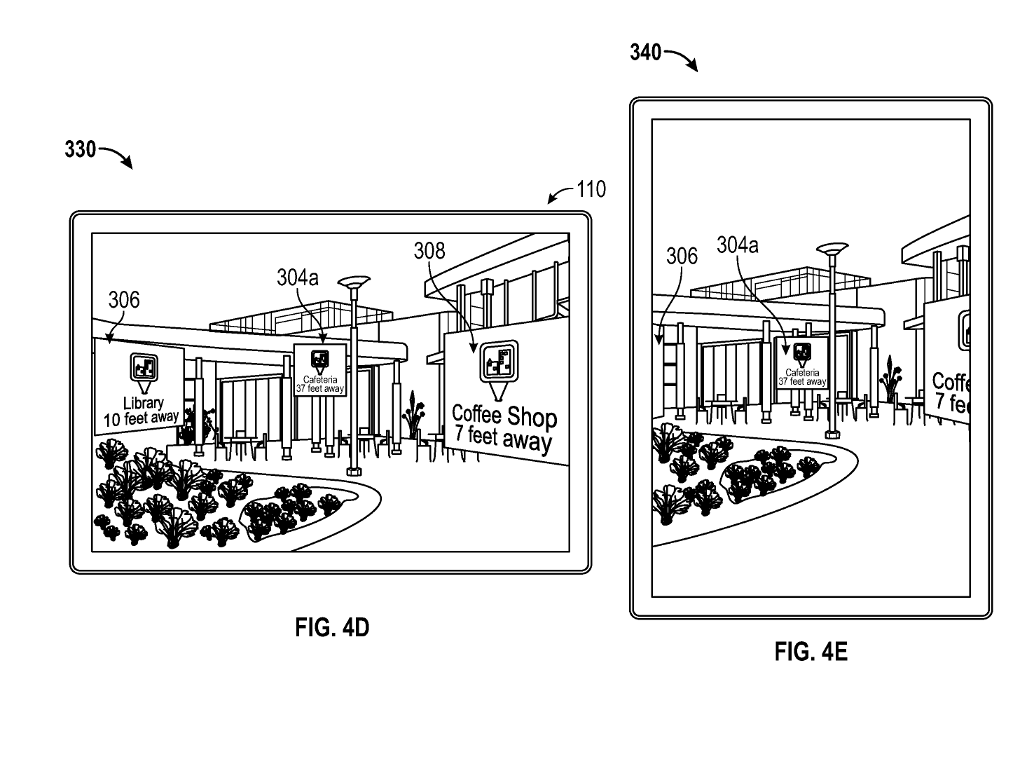

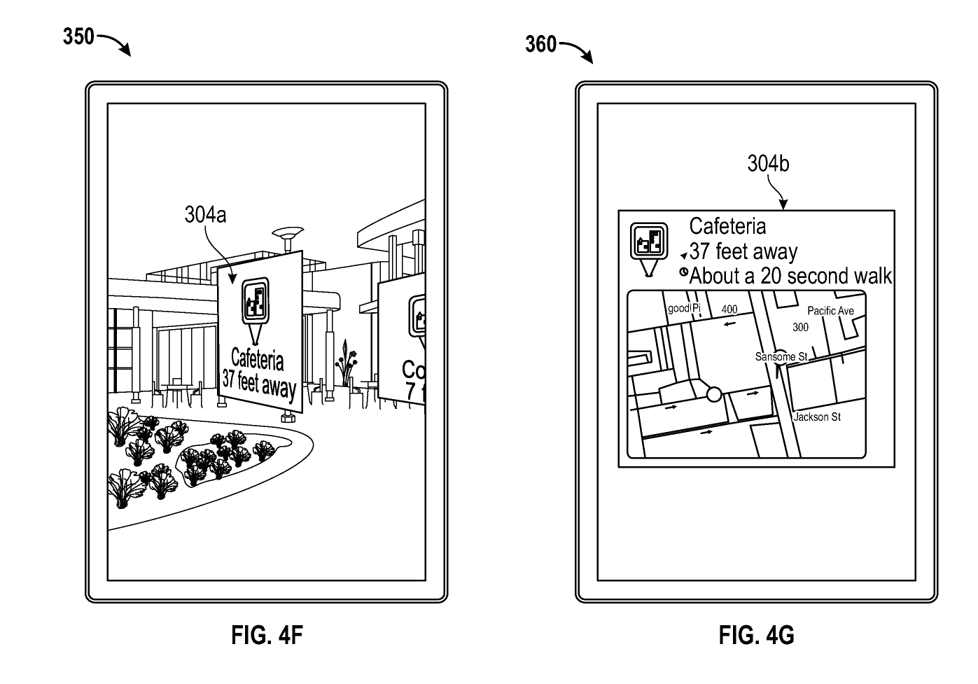

As illustrated in FIG. 4A, an illustration 300 of the tablet computer 110 running the augmented reality application 124, in subsequent step 204, the image 302 of the physical three-dimensional environment is provided for display on the tablet computer 110 within the simulated three-dimensional environment 318 based on a field of view of the camera 126. The simulated three-dimensional environment 318 is illustrated in phantom as the simulated three-dimensional environment 318 is not visible to the student user. Instead, in certain aspects, the simulated three-dimensional environment 318 is a surface layer on which computer-generated input can be displayed or associated.

FIG. 4B provides an example illustration 310 of the simulated three-dimensional environment 318. The simulated three-dimensional environment 318 is displayed as a spherical three-dimensional environment. In certain aspects, the simulated three-dimensional environment 318 can be displayed as a flat three-dimensional environment (e.g., cuboid-shaped environment). The simulated three-dimensional environment 318 can be also be displayed in other three-dimensional shapes, such as but not limited to a cube, cylinder, hexagonal prism, cone, square-based pyramid, triangular based pyramid, or triangular prism. In the simulated three-dimensional environment 318, each virtual object 304a, 306, and 308 is different and size in position based on its position within the simulated three-dimensional environment 318. For example, a first virtual object 308 is identified as being closer to the user in the simulated three-dimensional environment 318 than a second virtual object 306, so the first virtual object 308 appears larger than the second virtual object 306. Additionally, the first virtual object 308 is identified as being slightly to the right of the user in the simulated three-dimensional environment 318; therefore, the first virtual object 308 is slightly angled or rotated towards the right. Similarly, the second virtual object 306 is identified as being slightly to the left of the user in the simulated three-dimensional environment 318; therefore, the second virtual object 306 is slightly angled or rotated towards the right. The actual field of view 302 of the visual input device 126 (e.g., without running the augmented reality application 124) without the simulated three-dimensional environment 318 is provided in the illustration 320 of FIG. 4C.

Next, in step 205, computer-generated visual objects 306, 304a, and 308 are provided (e.g., on the surface layer) within the simulated three-dimensional environment 318 for overlaying on the displayed image 302 of the physical three-dimensional environment. As provided in the illustration 330 of FIG. 4D, which illustrates the augmented reality application 124 after the tablet computer has been rotated from a portrait orientation to a landscape orientation in order to better view the visual objects 306, 304a, and 308, each visual object 306, 304a, and 308 is associated with a position within the simulated three-dimensional environment.

The position of a visual object within the simulated three-dimensional environment correlates to the position, on the institutional campus, of the physical object associated with the visual object. For example, a first visual object 304a indicates a cafeteria is 37 feet away in a first direction substantially straight in front of the student user. A second visual object 306 indicates a library is 22 feet away in a second direction in front of and to the left of the student user. A third visual object 308 indicates a coffee shop is 7 feet away in a third direction in front of and to the right of the student user.

Each computer-generated visual object 306, 304a, and 308 is displayed using perspective projection within the simulated three-dimensional environment 318 onto the displayed image 302 of the physical three-dimensional environment based on the orientation data indicating the orientation of the tablet computer 110 within the physical three-dimensional environment. For example, in FIG. 4D, the second visual object 306 is slightly larger in size than the first visual object 304a due to the library being 15 feet closer to the user than the cafeteria. The third visual object 308 is slightly larger in size than the second visual object 306 due to the coffee shop being 15 feet closer to the user than the library. The visual objects 306, 304a, and 308 are also distorted based on their distance from the user and angles of rotation according to the perspective projection computed using the field of view of the image 302 of the physical three-dimensional environment as provided by the device camera 126. Specifically, the first visual object 304a appears directly in front of the student user, the second visual object 308 is rotated slightly towards the student user, based on the student user's position, in a first direction, and the third visual object 308 is rotated slightly towards the student user in a second direction. In certain aspects not illustrated, multiple visual objects that are displayed within the simulated three-dimensional environment along substantially the same z-axis (e.g., in a row, one behind another) can be displayed in a raised tier configuration.

A visual object can include any combination of text, a hyperlink, or an image (e.g., including video). A visual object can also provide audio (e.g., using a link). For example, a visual object can describe a location using text, include an image of the location, and include a link to a video associated with the location. In certain aspects, a visual object can be activated, and can, for example, approach the user and rotate to display additional information when activated. Because the visual object is displayed using a perspective projection, the visual object appears larger on the screen after having approached the user because the visual object is now much closer to the virtual camera. Such appearance is intended to mirror a physical environment in that physical objects do not expand in size in a physical environment when a person is interested in learning more about the physical object. Instead, a person approaches a physical object in order to examine the physical object more closely. Thus, the activation and approach of the visual object as disclosed herein further enforces coherence between the simulated virtual world and the physical three-dimensional world that a user is familiar with. Specifically, with reference to the illustration 340 of FIG. 4E, a visual object 304a is displayed near a cafeteria on the institutional campus. The visual object 304a indicates the cafeteria is 37 feet away, and therefore the visual object 304a appears much smaller than a visual object indicating a location closer to the student user. In order to obtain more information on the cafeteria, the student user activates the visual object 304a by touching the visual object on the touchscreen 116 of the tablet computer 110. In response, the visual object 304a rotates and approaches the student user, as displayed in the illustration 350 of FIG. 4F. The speed of the rotation and approach can be based on the distance between the current position of the student user and the visual object 304a. Upon completion of the rotation, an opposite side of the visual object 304b is displayed that provides additional information on the cafeteria, as displayed in the illustration 360 of FIG. 4G. Consequently, the use of proper field of view and perspective projection techniques allow for user interactions that are intuitive and consistent with the representation of a virtual environment that corresponds to a physical environment. The additional information includes a distance of the cafeteria, a map of a physical area surrounding the cafeteria, a location of the student user, a location of the cafeteria, and an estimated time to reach the cafeteria from the location of the student user. The process 200 then ends in step 206.

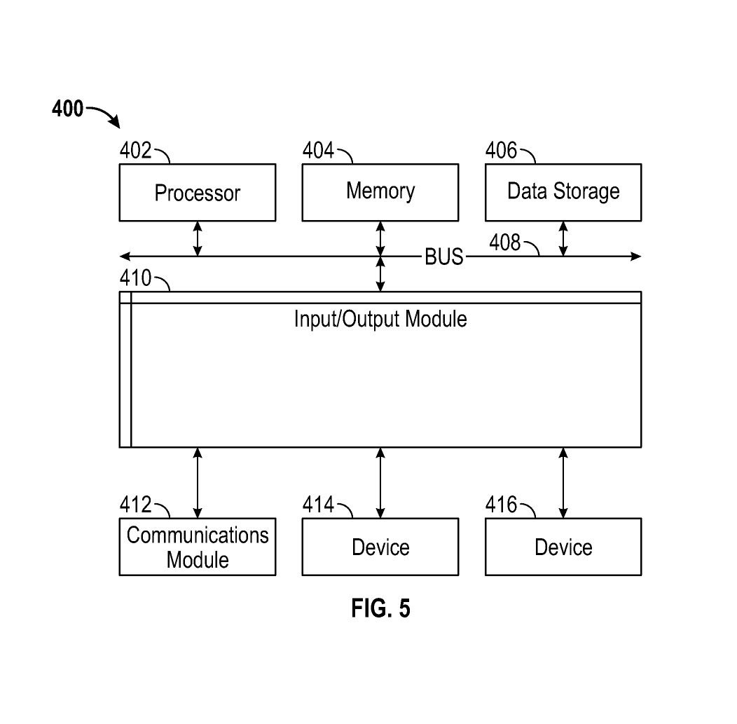

FIG. 5 is a block diagram illustrating an exemplary computer system 400 with which the client 110 of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., client 110) includes a bus 408 or other communication mechanism for communicating information, and a processor 402 (e.g., processor 112) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 120), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices (e.g., visual input device 126, orientation sensor(s) 128). The input/output module 410 can be any input/output module. Exemplary input/output modules 410 include data ports such as USB ports. The input/output module 410 is configured to connect to a communications module 412. Exemplary communications modules 412 (e.g., communications module 118) include networking interface cards, such as Ethernet cards and modems. In certain aspects, the input/output module 410 is configured to connect to a plurality of devices, such as an input device 414 (e.g., control input device 116) and/or an output device 416 (e.g., output device 114). Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 416 include display devices, such as a CRT (cathode ray tube) or LCD (liquid crystal display) monitor, for displaying information to the user.

According to one aspect of the present disclosure, the client 110 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Systems, methods, and machine-readable storage media for augmenting a view of a physical environment with computer-generated sensory input have been described. An augmented reality application can augment a view of a physical environment by displaying visual computer-generated sensory input using perspective projection. The positioning and behavior of each computer-generated sensory input is associated with a simulated three-dimensional environment that is generated to substantially mirror the physical environment. For example, the positioning and behavior of each computer-generated sensory input can be positioned and move within the simulated three-dimensional environment based on a field of view of a device providing the augmented reality interface.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A computer-implemented method for augmenting a view of a physical environment with computer-generated sensory input, the method comprising:
receiving visual data providing an image of a physical three-dimensional environment, and orientation data indicating an orientation of a device within the physical three-dimensional environment;
generating for display a simulated three-dimensional environment, wherein an orientation of the simulated three-dimensional environment is based on the orientation data indicating the orientation of the device within the physical three-dimensional environment, and the display of the simulated three-dimensional environment is based on the field of view of the device;
providing the image of the physical three-dimensional environment for display on the device within the simulated three-dimensional environment based on the field of view of the device; and
providing at least one computer-generated visual object within the simulated three-dimensional environment for overlaying on the displayed image of the physical three-dimensional environment,
wherein the at least one computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.

2. The computer-implemented method of claim 1, wherein the orientation data comprises data received from at least two of a geolocation sensor, a gyroscope, an accelerometer, and a compass

3. The computer-implemented method of claim 1, wherein the visual object is provided for display in front of a physical object in the physical three-dimensional environment associated with the visual object.

4. The computer-implemented method of claim 1, wherein the visual object is interactive.

5. The computer-implemented method of claim 4, wherein the visual object comprises at least one of text, a hyperlink, and an image.

6. The computer-implemented method of claim 4, wherein the visual object appears to approach the user when activated.

7. The computer-implemented method of claim 4, wherein the visual object rotates to display additional information associated with the visual object when activated.

8. The computer-implemented method of claim 1, wherein a field of view of the simulated three-dimensional environment is defined by the field of view of a camera display input of the device.

9. The computer-implemented method of claim 1, wherein the visual object is associated with a position within the simulated three-dimensional environment.

10. The computer-implemented method of claim 9, wherein the simulated three-dimensional environment is displayed as a spherical three-dimensional environment or a flat three-dimensional environment.

11. The computer-implemented method of claim 1, wherein multiple visual objects displayed within the simulated three-dimensional environment along substantially the same z-axis are displayed in a raised tier configuration.

12. A system for augmenting a view of a physical environment with computer-generated sensory input, the system comprising:
a memory comprising instructions;
a processor configured to execute the instructions to:
receive visual data providing an image of a physical three-dimensional environment, and orientation data indicating an orientation of a device within the physical three-dimensional environment;
generate for display a simulated three-dimensional environment, the orientation of the simulated three-dimensional environment based on the orientation data indicating the orientation of the device within the physical three-dimensional environment, and the display of the simulated three-dimensional environment is based on the field of view of the device;
provide the image of the physical three-dimensional environment for display on the device within the simulated three-dimensional environment based on a field of view of the device; and
provide at least one computer-generated visual object within the simulated three-dimensional environment for overlaying on the displayed image of the physical three-dimensional environment,
wherein the at least one computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.

13. The system of claim 12, wherein the orientation data comprises data received from at least two of a geolocation sensor, a gyroscope, an accelerometer, and a compass

14. The system of claim 12, wherein the visual object is provided for display in front of a physical object in the physical three-dimensional environment associated with the visual object.

15. The system of claim 12, wherein the visual object is interactive.

16. The system of claim 15, wherein the visual object comprises at least one of text, a hyperlink, and an image.

17. The system of claim 15, wherein the visual object appears to approach the user when activated.

18. The system of claim 15, wherein the visual object rotates to display additional information associated with the visual object when activated.

19. The system of claim 12, wherein a field of view of the simulated three-dimensional environment is defined by a field of view of a camera display input of the device.

20. The system of claim 12, wherein the visual object is associated with a position within the simulated three-dimensional environment.

21. The system of claim 20, wherein the simulated three-dimensional environment is displayed as a spherical three-dimensional environment or a flat three-dimensional environment.

22. The system of claim 12, wherein multiple visual objects displayed within the simulated three-dimensional environment along substantially the same z-axis are displayed in a raised tier configuration.

23. A machine-readable storage medium comprising machine-readable instructions for causing a processor to execute a method for augmenting a view of a physical environment with computer-generated sensory input, the method comprising:
receiving visual data providing an image of a physical three-dimensional environment, and orientation data indicating an orientation of a device within the physical three-dimensional environment;
generating for display a simulated three-dimensional environment, the orientation of the simulated three-dimensional environment based on the orientation data indicating the orientation of the device within the physical three-dimensional environment, and the display of the simulated three-dimensional environment is based on the field of view of the device;
providing the image of the physical three-dimensional environment for display on the device within the simulated three-dimensional environment based on the field of view of the device; and
providing at least one computer-generated visual object within the simulated three-dimensional environment for overlaying on the displayed image of the physical three-dimensional environment,
wherein the at least one computer-generated visual object is displayed using perspective projection within the simulated three-dimensional environment onto the displayed image of the physical three-dimensional environment based on the orientation data indicating the orientation of the device and position data indicating a position of the device within the physical three-dimensional environment.
